(19) United States
(12) Patent Application Publication
(10) Pub. No.: US 2021/0012727 A1
(43) Pub. Date: Jan. 14, 2021

(54) METHOD FOR CONTROLLING LIGHT SOURCE OF DISPLAY DEVICE AND LCD DEVICE

(71) Applicants: Interface Technology (ChengDu) Co., Ltd., Chengdu (CN); INTERFACE OPTOELECTRONICS (SHENZHEN) CO., LTD., Shenzhen (CN); GENERAL INTERFACE SOLUTION LIMITED, Zhunan (TW)

(72) Inventors: CHIEN-WEN CHANG, Zhunan (TW); TA-JEN HUANG, Zhunan (TW)

(21) Appl. No.: 16/661,194

(22) Filed: Oct. 23, 2019

(30) Foreign Application Priority Data
Jul. 12, 2019 (CN) 201910629248.7

(51) Int. Cl. G09G 3/34

(52) U.S. Cl. CPC G09G 3/3426; G09G 2320/0626; G09G 2320/0233

(57) ABSTRACT

A method for controlling a light source of a liquid crystal display (LCD) device includes dividing each frame of image to be displayed into a plurality of areas and obtaining a first brightness value of each area. Any difference between the first brightness values of any two adjacent areas is determined to be less than or greater than a preset threshold. If greater, the first brightness value of at least one of the two adjacent areas is adjusted to be a second brightness value, so as to increase the difference in brightness between the adjacent two areas. If less than or equal, the second brightness value of each area is rendered equal to the first brightness value. Light intensity or brightness of the light-emitting elements is thus adjusted for a high contrast display of areas where this is required.

### FIELD

The subject matter herein generally relates to a method for controlling a light source of a display device and a liquid crystal display device.

### BACKGROUND

In a liquid crystal display (LCD) panel, when all the backlights are turned on, the liquid crystal molecules do not block all the backlights, so there is light leakage onto the display screen, thus the LCD panel cannot achieve a deep black appearance. In additional, light leakage may blur the image edges and prevent proper layering of a picture when high contrast images are displayed.

Therefore, there is room for improvement in the art.

### BRIEF DESCRIPTION OF THE DRAWINGS

Implementations of the present technology will now be described, by way of embodiment, with reference to the attached figures.

FIG. 1 is a schematic view of a liquid crystal display device according to an embodiment of the present disclosure.

FIG. 2 is a view of a light-source controlling system according to an embodiment of the present disclosure.

FIG. 3 is a view showing partitioning of an image to be displayed.

FIG. 4 is a graph showing relationships between target brightness value and output brightness ratio at different gamma values.

FIG. 5A is a schematic diagram showing a black state when the backlight source being turned off under a conventional backlight pulse width modulation.

FIG. 5B is a schematic diagram showing a bright state when the backlight source being turned on under the conventional backlight pulse width modulation.

FIG. 5C is a schematic diagram showing an operation state of a backlight unit using a conventional area dimming technology.

FIG. 5D is a schematic diagram showing an operation state of a backlight unit according to an embodiment of the present disclosure.

FIG. 6A is a pulse sequence diagram of timing signals and display signals of a conventional area dimming technology.

FIG. 6B is a pulse sequence diagram of display signals and timing signals according to an embodiment of the present disclosure.

FIG. 6C and FIG. 6E are pulse diagrams showing changes of the output voltage of the driving signals over time for any two backlight units in the conventional area dimming technology.

FIG. 6D and FIG. 6F are pulse diagrams showing changes of the output voltage of the driving signals over time for two embodiments of the present disclosure.

FIG. 7 is a flowchart of a method for controlling a light source.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The term “coupled” is defined as coupled, whether directly or indirectly through intervening components, and is not necessarily limited to physical connections. The connection can be such that the objects are permanently coupled or releasably coupled. The term “comprising” when utilized, means “including, but not necessarily limited to”; it specifically indicates open-ended inclusion or membership in the so-described combination, group, series, and the like.

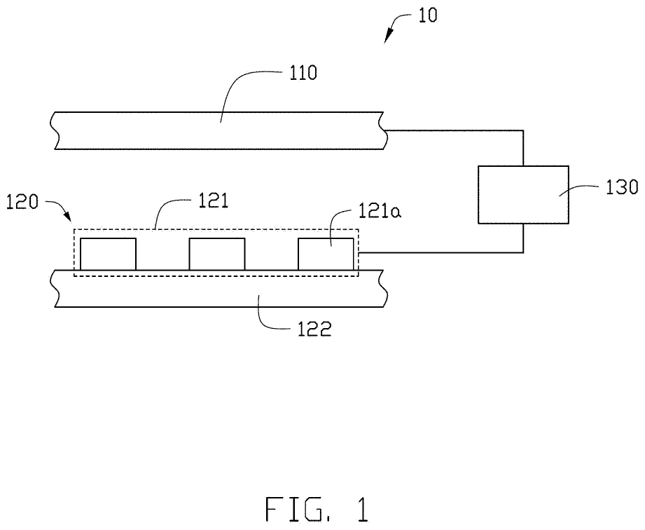

As shown in FIG. 1, an LCD device 10 includes a backlight module 120 and an LCD panel 110. The backlight module 120 includes a back plate 122 and a backlight source 121 on the back plate 122. The backlight source 121 includes a plurality of light-emitting elements 121a. Each light-emitting element 121a can independently on or off. The liquid crystal display panel 110 is on an optical path of the backlight source 121, and displays images by using light of the backlight source 121. The liquid crystal display device 10 further includes a light-source controlling system 130 for controlling light intensities of the light-emitting elements 121a.

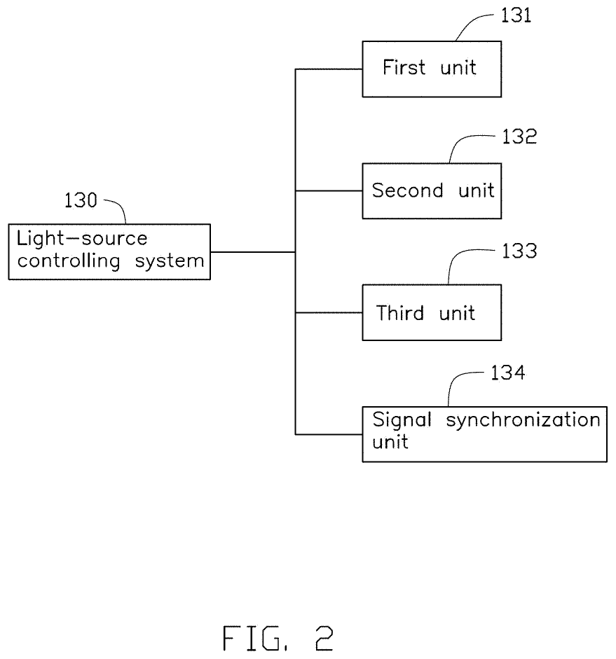

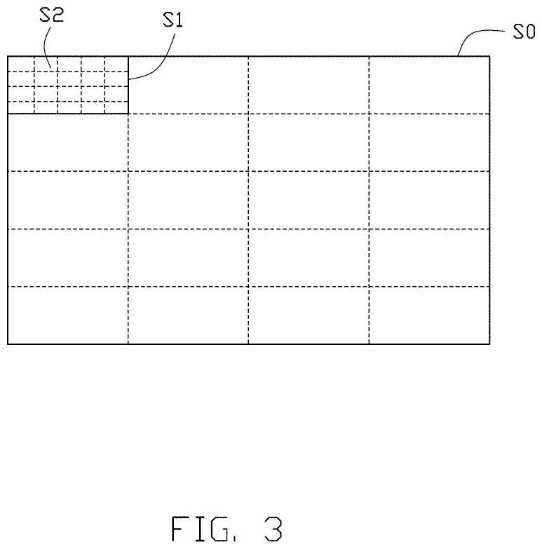

As shown in FIG. 2, the light-source controlling system 130 includes a first unit 131, a second unit 132, and a third unit 133. The first unit 131 is configured to divide the image S0 to be displayed into a plurality of areas S1 as shown in FIG. 3. Each area S1 corresponds to a plurality of pixels S2 of the image S0 to be displayed. A first brightness value of each area S1 is determined according to data of the image S0 to be displayed. The second unit 132 is configured to determine whether a difference between the first brightness values of any two adjacent areas S1 is greater than a preset threshold, and if yes, the first brightness value of at least one area S1 is adjusted to be a second brightness value to increase the difference between. If not, the second brightness value of each area S1 is rendered as equal to the first brightness value. The third unit 133 is configured to adjust the light intensities of the light-emitting elements 121a to match the second brightness value of each area S1. Each area S1 of the image S0 corresponds to at least one light-emitting element 121a.

The third unit 133 adjusts the light intensity of the light-emitting element 121a to be close to the second brightness values of each area S1. For any two adjacent areas S1, a difference of the second brightness values is greater than a difference of the first brightness values. In actual operation, since the light intensity of the light-emitting elements 121a corresponding to each area S1 may be lower than the second brightness value, the actual light intensity of the light-emitting elements 121a corresponding to each area S1 may be equal to the first brightness value.

In this embodiment, the light-emitting element 121a is a light-emitting diode (LED). Specifically, the light-emitting element 121a may be a conventional sized LED or a mini LED. The mini LED refers to an LED made of LED dies having a size of 0.01-0.1 mm and two adjacent light-emitting points having a center-to-center distance of 0.1-1.0 mm.

For example, for a to-be-displayed image S0 having a resolution of 1800×1200, a display bit depth is z bits, and the image S0 may be partitioned to be an array of 24×16 areas S1, thus each area S1 corresponds to 75×75 pixels S2. It can be understood that the above-described partitioning of the image S0 is only an example, a number of the areas S1 for each frame of the image S0 to be displayed and a number of the pixels S2 of each area S1 can be adjusted according to actual conditions.

In this embodiment, a gray value of each pixel S2 includes a first primary color gray value, a second primary color gray value, and a third primary color gray value. The first primary color gray values, the second primary color gray values, the third primary color gray values, and the display bit depth z (bit) of the pixels S2 in each area S1 are combined to obtain the first brightness value of each area S1. The first primary color gray value may be a red gray value, the second primary color gray value may be a green gray value, and the third primary color gray value may be a blue gray value.

In this embodiment, the first primary color gray values of the pixels S2 of each area S1 are averaged to obtain a first color gray average value of each area S1 and the second primary color gray values of the pixels S2 of each area S1 are averaged to obtain a second color gray average value of each area S1. The third primary color gray values of the pixels S2 of each area S1 are averaged to obtain a third color gray average value of each area S1. The first brightness value of each area S1 is obtained based on the first color gray average value Rₙ, the second color gray average value Gₙ, the third color gray average value Bₙ, and the display bit depth. Further, the first brightness value of each area S1 is a maximum value of (100%×Rₙ)/z, (100%×Gₙ)/z, and (100%×Bₙ)/z. When the display bit depth is 8 bits, the first brightness value of each area S1 is a maximum value of (100%×Rₙ)/8, (100%×Gₙ)/8 and (100%×Bₙ)/8. It can be understood that the first brightness value is a parameter for evaluating a relative gray level of the different areas S1 of the image S0 to be displayed. The calculation method of the first brightness value is not limited to the above-described method and can be other method.

In order to increase the difference in brightness values of adjacent areas S1 to increase a contrast of the adjacent areas S1, the second unit 132 may reduce the first brightness value of the area S1 in adjacent areas S1 where the first brightness value is lower or may increase the first brightness value of the area S1 in the adjacent areas S1 where the first brightness value is great.

Assuming that the first brightness values of the two adjacent areas S1 are a and b, respectively, wherein a>b, and the preset threshold is n. If the difference between the first brightness values of the two adjacent areas S1 reaches the preset threshold n, that is, a−b≥n, then the first brightness value of the area S1 having the first brightness value b can be reduced by x %, and/or the first brightness value of the area S1 with the first brightness value a can be increased by x %. Since a conventional area dimming technology realizes display of the image S0 to be displayed by partially turning on or turning off of the backlight source 121, the brightness-darkness contrasts and fineness of the display images are limited. Adding the second unit 132 increases the difference between the first brightness values of the adjacent areas S1 to obtain the second brightness value, this improves the brightness-darkness contrasts and fineness of the display images.

For example, assuming that the preset threshold value n=127 brightness tones (hereinafter just “tones”), the first brightness values of the two adjacent areas S1 are 31 tones and 159 tones, respectively. The percentage x % may be between 5% and 20%, and if x % is taken to be 20%, then x %=20%. The difference between the first brightness values of the two adjacent areas S1 is 159−31=128 tones, and the 128 tones is >127 tones; that is, the difference between the first brightness values of the two adjacent areas S1 is greater than the preset threshold value n, so that the first brightness value of the area S1 with the lower first brightness value of 31 tones can be reduced by 20%, (i.e. the first brightness value of the area S1 is reduced from 31 tones to be 31 minus 20% of 31=24.8, call this 24 tones). The first brightness value of the area S1 with the greater first brightness value of 159 tones is increased from 159 tones to be 159 plus 20% of 159=190.8, call this 191 tones. The difference between the first brightness values of the two adjacent areas S1 is thus 191 minus 24=167 tones, which is an increase of 39 tones compared to the original difference of 128 tones. The difference between the second brightness values of the adjacent areas S1 is now 167 tones.

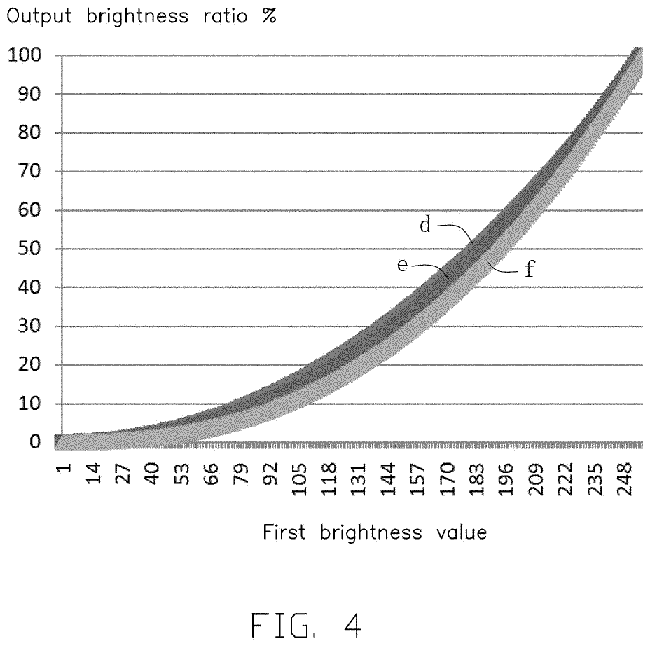

Since human eye is more sensitive to changes in a dark tones under normal light and dark conditions, the brightness perceived by the human eye when viewing the liquid crystal display panel 110 is not linearly related to the actual output brightness of the liquid crystal display panel 110. Thus gamma value is used to correct the brightness of the display screen perceived by the human eye. FIG. 4 shows the relationships of the first brightness value and the output brightness ratio under the condition that the gamma values are 2.0, 2.2, and 2.4, respectively. For example, when the gamma value is 2.2, the first brightness value is 31 tones and the output brightness ratio of the area S1 is about 0.97%. The output brightness ratio of the area S1 with the first brightness value of 159 tones is about 35.37%. Then before the second unit 132 performs its operation, the brightness contrast ratio of adjacent areas S1 is 35.37%/0.97%≈136.46. After the second unit 132 performs the operation as above, the output brightness ratio of the area S1 with the first brightness value of 24 tones is about 0.55%, and the output brightness ratio of the area S1 with the first brightness value of 191 tones is about 53.56%. The brightness contrast ratio of the two adjacent areas S1 is 53.56%/0.55%≈97.38, and the output brightness contrast of the two adjacent areas S1 is increased by 97.38−53.56=43.82. After the first brightness values of any two adjacent areas S1 is selectively adjusted by the second unit 132, the existing difference in first brightness values within adjacent areas S1 greater than the preset threshold is increased. As a result, the contrast and fineness of the entire display image is also increased.

It can be understood that the preset threshold values n and x % can be designed according to actual need. The greater the value of x %, the greater will be the difference between the first brightness values of the adjacent areas S1 after the second unit 132 applies an adjustment, and the greater will be the light and dark contrast and the fineness of the display images.

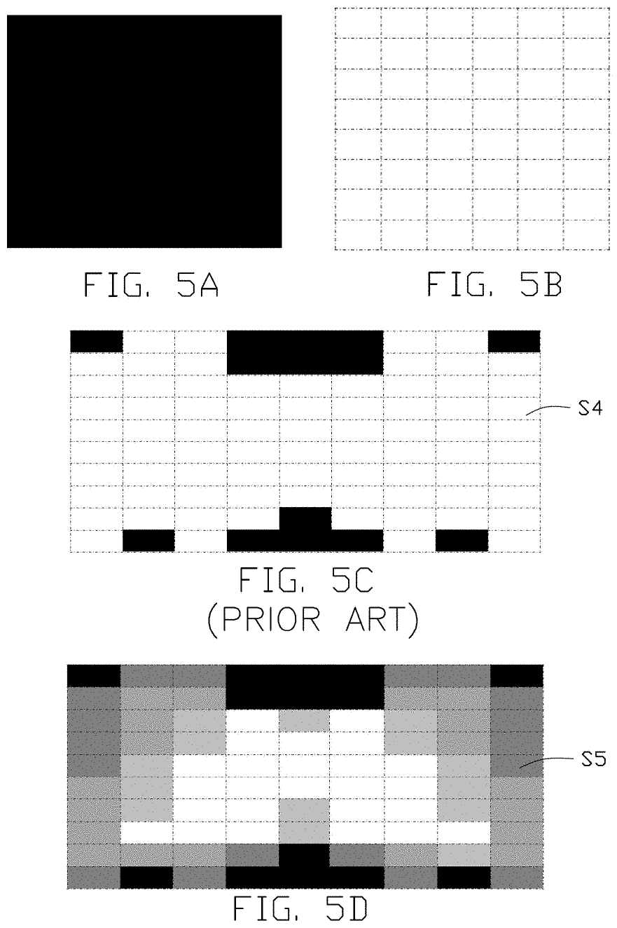

FIG. 5A shows a state when the backlight source is completely dark under backlight pulse width modulation. FIG. 5B shows a state when the backlight source is totally bright under backlight pulse width modulation. A conventional backlight pulse width modulation can only control light output of the backlight source by turning on or off all the light-emitting elements. The image edges are blurred and the picture is not layered when the liquid crystal display panel displays high contrast images. FIG. 5C shows operation of a backlight unit S4 in the conventional area dimming technology. Compared with the conventional backlight pulse width modulation technology, the area dimming technology performs partition control on the backlight source to obtain a plurality of backlight units S4. However, the light and dark distribution of the light emitted by the backlight sources can only be adjusted by turning on or off the backlight units S4. FIG. 5D shows an operation of the backlight units S5 of the liquid crystal display device 10 according to an embodiment of the present disclosure. The third unit 133 performs partition controlling on the light-emitting elements 121a to obtain a plurality of backlight units S5. Each backlight unit S5 corresponds to at least one light-emitting element 121a, and each backlight unit S5 corresponds to one area S1 of the image S0 to be displayed. The third unit 133 controls the light-emitting intensity of the backlight unit S5 according to the first brightness value of each area S1 of the image S0 to be displayed. Compared with a conventional area dimming technology, the liquid crystal display device 10 of the present disclosure can independently control the brightness of different backlight units S5 according to the data of the image S0 to be displayed, which is beneficial to improve the contrast and layering of the display images.

Referring to FIG. 2 again, the light-source controlling system 130 further includes a signal synchronization unit 134. The signal synchronization unit 134 is configured for acquiring timing signals of each frame of image S0 to be displayed, and sending display signals to the liquid crystal display panel 110 according to the timing signals. The display signals drive the liquid crystal display panel 110 to display image S0 to be displayed at a predetermined time. The third unit 133 sends driving signals to the light-emitting elements 121a in accordance with the display signals, and the light-emitting elements 121a emit light required for display the frame of image S0 at the predetermined time. The timing signal can be a line sync (HSYNC) signal, a field sync (VSYNC) signal, or an output enable (OE) signal.

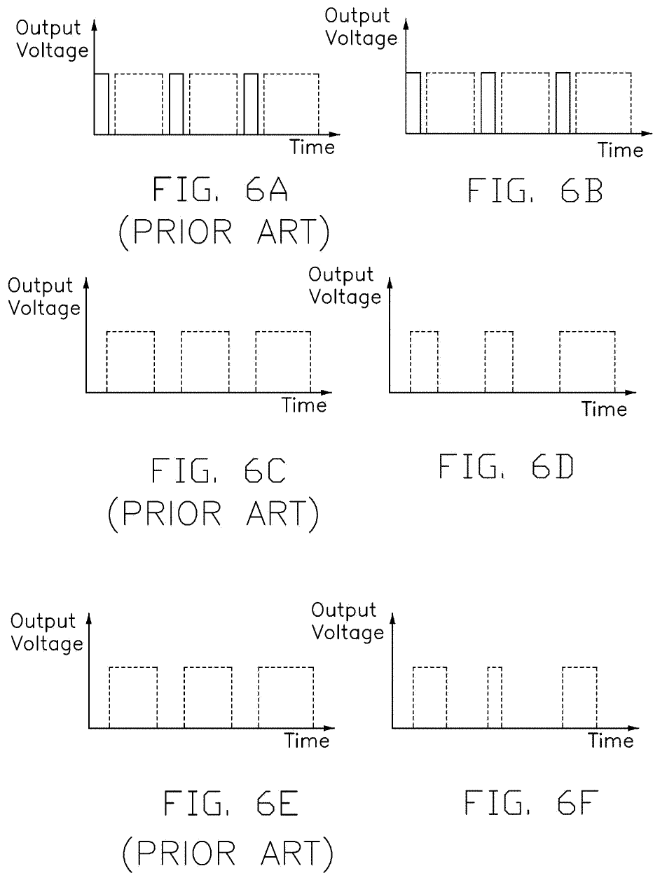

FIG. 6A shows timing signals and display signals of a conventional area dimming technology. FIG. 6B shows display signals and timing signals according to an embodiment of the present disclosure, wherein the solid line corresponds to the timing signals (specifically VSYNC) of the image S0 to be displayed, and the dotted line corresponds to the display signals.

FIG. 6C and FIG. 6E show changes of the output voltage of the driving signals with time for any two backlight units S4 in the conventional area dimming technology. The luminance (or brightness) of each backlight unit S4 is a macroscopic representation of an amount of output light during a fixed time. The time at which the driving signal of the light-emitting element corresponding to each backlight unit S4 is at a high level determines the amount of output light. It can be seen from FIG. 6C and FIG. 6E that the amounts of output light for the output signals of the two backlight units S4 in the same time are constant. That is, the light-emitting elements corresponding to the two backlight units S4 have a same brightness of light emission (assuming that the two backlight units S4 are all turned on at the same time). The pulse sequence of the output voltage of the driving signal is synchronized with the pulse sequence of the output voltage of the display signal in FIG. 6A.

FIG. 6D and FIG. 6F show changes of the output voltage of the driving signals over time, in two embodiments of the present disclosure. It can be seen that the light-emitting elements 121a of each backlight unit S5 can emit different amounts of light as outputs in the same time. In other words, each backlight unit S5 can have different instant brightness. The pulse sequence of the driving signal of each backlight unit S5 is synchronized in time with the pulse sequence of the display signal in FIG. 6B. Under a joint action of the third unit 133 and the signal synchronizing unit 134, in the display time of each frame of the image S0, the driving signal received by the light emitting element 121a is time-synchronized with the display signal received by the liquid crystal display panel 110, thus the frame of the image S0 is displayed.

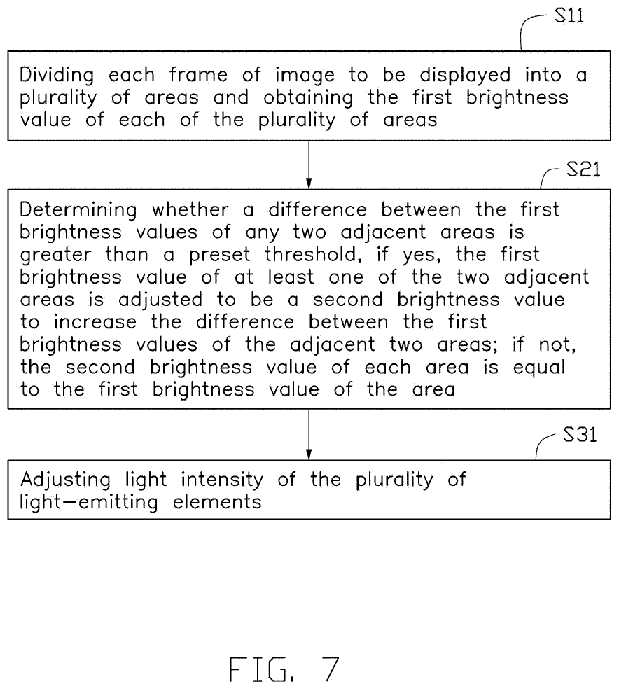

FIG. 7 illustrates a flowchart of a method for controlling a light source of the liquid crystal display device 10. The example method is provided by way of example, as there are a variety of ways to carry out the method. Each block shown in FIG. 7 represents one or more processes, methods, or subroutines, carried out in the exemplary method. Furthermore, the illustrated order of blocks is by example only and the order of the blocks can change. The exemplary method can begin at block S11 according to the present disclosure. Depending on the embodiment, additional steps can be added, others removed, and the ordering of the steps can be changed.

At block S11: each frame of image to be displayed is divided into a plurality of areas, and obtain the first brightness value of each area according to data of the image to be displayed. Each area corresponds to a plurality of pixels of the image to be displayed, and corresponds to at least one light-emitting element.

At block S21: whether a difference between the first brightness values of any two adjacent areas is greater than a preset threshold is determined; if yes, at least the first brightness value of one area S1 is adjusted to be a second brightness value to increase the difference; if not, the second brightness value of each area S1 is rendered equal to the first brightness value of the area S1.

Specifically, the difference between the first brightness values of any two adjacent areas can be increased by reducing the first brightness value of the area with a lower first brightness value or increasing the first brightness value of the area with a greater first brightness value. In one embodiment, the first brightness value of the area with a lower first brightness value may be reduced by 5% to 20%, and/or the first brightness value of the area with a greater first brightness value may be increased by 5% to 20% to obtain the second brightness values.

At block S31: the light intensity of the light-emitting elements is adjusted according to the second brightness value of each area.

Specifically, the plurality of light-emitting elements may be partition controlled to obtain a plurality of backlight units, and each backlight unit corresponds to at least one light emitting elements. Each backlight unit corresponds to one area of the image to be displayed, and the light intensity of the light-emitting element corresponding to the backlight unit is controlled according to the second brightness value of each area of the image to be displayed.

In one embodiment, the method for controlling a light source further includes: acquiring timing signals of each frame of image S0 to be displayed, and sending display signals to the liquid crystal display panel according to the timing signals. The display signals drive the liquid crystal display panel to display image corresponding to the image S0 to be displayed at a predetermined time. The timing signal can be a line sync (HSYNC) signal, a field sync (VSYNC) signal, or an output enable (OE) signal.

In one embodiment, the gray value of each pixel of each frame of image to be displayed includes a first primary color gray value, a second primary color gray value, and a third primary color gray value. The first primary color gray values, the second primary color gray values, the third primary color gray values, and the display bit depth of the pixels in each area are combined to obtain the first brightness value of each area.

It is to be understood, even though information and advantages of the present embodiments have been set forth in the foregoing description, together with details of the structures and functions of the present embodiments, the disclosure is illustrative only; changes may be made in detail, especially in matters of shape, size, and arrangement of parts within the principles of the present embodiments to the full extent indicated by the plain meaning of the terms in which the appended claims are expressed.

What is claimed is:

1. A method for controlling a light source of a liquid crystal display device, the light source comprising a plurality of light-emitting elements, the method comprising:
dividing each frame of image to be displayed into a plurality of areas and obtaining the first brightness value of each of the plurality of areas, each of the plurality of areas corresponding to a plurality of pixels of the image to be displayed and corresponding to at least one of the plurality of light-emitting elements;
determining whether a difference between first brightness values of any two adjacent areas is greater than a preset threshold, wherein
if the difference is greater than the preset threshold, the first brightness value of at least one of the two adjacent areas is adjusted to be a second brightness value to increase the difference between the first brightness values of the adjacent two areas, and
if the difference is not greater than the preset threshold, the second brightness value of each area is equal to the first brightness value of the area; and
adjusting light intensity of the plurality of light-emitting elements according to the second brightness value of each of the plurality of areas.

2. The method of claim 1, wherein the method of increasing the difference between the first brightness values of the adjacent two areas comprises reducing the first brightness value of one of the adjacent two areas with a lower first brightness value.

3. The method of claim 2, wherein the first brightness value of the one of the adjacent two areas with a lower first brightness value is reduced by 5% to 20%.

4. The method of claim 1, wherein the method of increasing the difference between the first brightness values of the adjacent two areas comprises increasing the first brightness value of one of the adjacent two areas with a greater first brightness value.

5. The method of claim 4, wherein the first brightness value of the one of the adjacent two areas with a greater first brightness value is increased by 5% to 20%

6. The method of claim 1, wherein the method of adjusting light intensity of the plurality of light-emitting elements comprises:
dividing the plurality of light-emitting elements into a plurality of backlight units, and each of a plurality of backlight units corresponding to at least one light emitting elements; and
each of the plurality of backlight units corresponding to one of the plurality of areas of the image to be displayed, and adjusting light intensity of the light-emitting element corresponding to each of the plurality of backlight units according to the second brightness value of each area of the image to be displayed.

7. The method of claim 1, further comprising:
acquiring timing signals of each frame of image to be displayed; and
sending display signals to the liquid crystal display panel according to the timing signals; the display signals drive the liquid crystal display panel to display image corresponding to the image to be displayed at a predetermined time.

8. The method of claim 1, wherein the timing signal is a line sync signal, a field sync signal, or an output enable signal.

9. The method of claim 1, wherein a gray value of each pixel of each frame of image to be displayed includes a first primary color gray value, a second primary color gray value, and a third primary color gray value; the first primary color gray values, the second primary color gray values, the third primary color gray values, and a display bit depth of the pixels in each area are combined to obtain the first brightness value of each area

10. A liquid crystal display device, comprising:
a backlight source, the backlight source comprising a plurality of light-emitting elements which are independently controllable;
a liquid crystal display panel configured to display images with light from the backlight source; and
a light-source controlling system configured to controlling the light intensities of the plurality of light-emitting elements, the light-source controlling system comprising:
a first unit, the first unit configured to divide the image to be displayed into a plurality of areas and determine a first brightness value of each of the plurality of areas, each of the plurality of areas corresponding to a plurality of pixels of the image to be displayed and at least one of the plurality of light-emitting elements;
a second unit, the second unit configured to determine whether a difference between first brightness values of any two adjacent areas is greater than a preset threshold, wherein
if the difference is greater than the preset threshold, the first brightness value of at least one of the two adjacent areas is adjusted to be a second brightness value to increase the difference between the first brightness values of the adjacent two areas, and
if the difference is not greater than the preset threshold, the second brightness value of each area is equal to the first brightness value of the area; and
a third unit, the third unit configured to adjust light intensities of the plurality of light-emitting elements according to the second brightness value of each area.

11. The liquid crystal display device of claim 10, wherein the light-source controlling system further comprises a signal synchronization unit, the signal synchronization unit is configured for acquiring timing signals of each frame of image to be displayed, and sending display signals to the liquid crystal display panel according to the timing signals; the display signals is configured to drive the liquid crystal display panel to display image corresponding to the image to be displayed at a predetermined time.

12. The liquid crystal display device of claim 11, wherein the third unit is configured to send driving signals to the plurality of light-emitting elements in accordance with the display signals, and the plurality of light-emitting elements are configured to emit light for displaying of the frame of image to at the predetermined time.

13. The liquid crystal display device of claim 11, wherein the timing signal is a line sync signal, a field sync signal, or an output enable signal.
